(19) United States
(12) Patent Application Publication
(10) Pub. No.: US 2013/0314947 A1
(43) Pub. Date: Nov. 28, 2013

(54) LED LIGHT BULB CONCURRENTLY SERVING AS NIGHT LIGHT

(71) Applicants: PO-YU YANG, NEW TAIPEI CITY (TW); CHIH-MIN CHANG, NEW TAIPEI CITY (TW)

(72) Inventors: PO-YU YANG, NEW TAIPEI CITY (TW); CHIH-MIN CHANG, NEW TAIPEI CITY (TW)

(73) Assignee: PARA LIGHT ELECTRONICS CO., LTD., NEW TAIPEI CITY (TW)

(21) Appl. No.: 13/477,202

(22) Filed: May 22, 2012

(51) Int. Cl. F21V 29/00; F21V 13/02

(52) U.S. Cl. 362/641

(57) ABSTRACT

Disclosed is an LED light bulb that also serves a night light, including a reflection structure, a cover, a circuit board, a heat dissipater, a power connector, and a light guide bar. The heat dissipater is mounted between and coupled with a cover and a power connector, the reflection structure is mounted to a top of the cover, the light guide bar has one end connected to the reflection structure, the multiple LED elements mounted on the circuit board which is attached to the heat dissipater, and the LED elements emits light that gets incident to the light guide bar.

### FIELD OF THE INVENTION

The present invention relates to an LED (Light-Emitting Diode) light bulb, and in particular to an LED light bulb that concurrently serves as a night light.

### BACKGROUND OF THE INVENTION

A conventional LED light bulb often comprises a heat dissipater, an LED light source, a cover, and a head. However, no reflective structure and light guide bar are actually included. Further, the conventional LED light bulb only functions of regular illumination and does generally not serve as a night light and provide large-angle light emission. These are long known problems.

Thus, the present invention aims to provide an LED light bulb that concurrently serves as a night light and has a large angle of light emission.

### SUMMARY OF THE INVENTION

An object of the present invention is to provide an LED (Light-Emitting Diode) light bulb that also serves a night light, in which a reflection structure is mounted to a top of a cover and a light guide bar is connected to the reflection structure so that, in a condition of being used with a cover, a switch can be operated to have some LED elements of a different color to give off light of said different color that is guided by the light guide bar to project out of the top of the cover for lighting as a night light so that the LED light bulb can also serve as a night light. Further, the switch can be operated to have other LED elements give off light that is reflected by the reflection structure to expand the light emission angle of the LED light bulb.

To achieve the above object, the present invention provides an LED light bulb that also serves a night light, which comprises a reflection structure, a cover, a circuit board, a heat dissipater, a power connector, and a light guide bar. The reflection structure is mounted to a top of the cover. The heat dissipater has a top end coupled to a bottom end of the cover. The circuit board comprises multiple LED elements mounted thereon. The circuit board is attached to the heat dissipater in such a way that the circuit board is housed in the cover. The light guide bar has one end connected to the reflection structure and an opposite end opposing and close to at least one of the LED elements of the circuit board. The at least one of the LED elements emits light that gets incident to the light guide bar. The power connector is mounted to a bottom end of the heat dissipater.

As such, an additional function as a night light can be realized and the light emission angle of the LEG light bulb can be expanded.

### BRIEF DESCRIPTION OF THE DRAWINGS

The present invention will be apparent to those skilled in the art by reading the following description of preferred embodiments thereof with reference to the drawings, in which:

FIG. 1 is an exploded view showing a first embodiment according to the present invention;

FIG. 2 is an exploded view showing a second embodiment according to the present invention;

FIG. 3 is an exploded view showing a third embodiment according to the present invention; and

FIG. 4 is an exploded view showing a fourth embodiment according to the present invention.

### DETAILED DESCRIPTION OF THE PREFERRED EMBODIMENTS

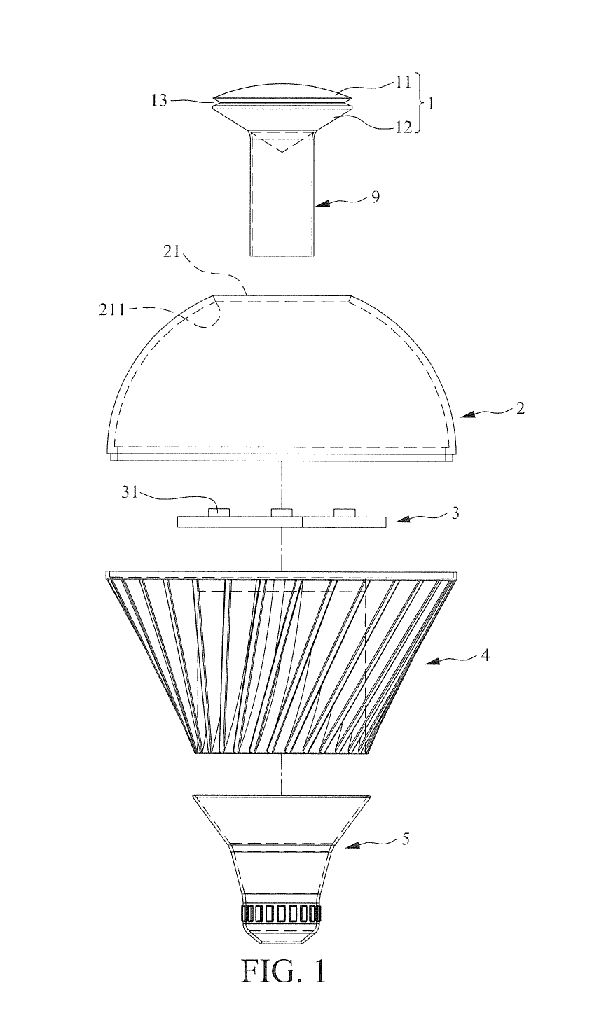

The present invention provides an LED (Light-Emitting Diode) light bulb that concurrently serves as a night light, of which first, second, third, and fourth embodiments are respectively illustrated in FIGS. 1, 2, 3, and 4.

Reference is now made to the first embodiment of the present invention shown in FIG. 1, which comprises a reflection structure 1, a cover 2, a circuit board 3, a heat dissipater 4, a power connector 5, and a light guide bar 9.

The reflection structure 1 comprises at least one optic curved surface that is of delicate and precise optic design, so that reflection of light can be effected through the optic curved surface. The reflection structure 1 is detachably mounted to a top of the cover 2. The heat dissipater 4 has a top end coupled to a bottom end of the cover 2. The circuit board 3 comprises a plurality of LED elements 31. The circuit board 3 is attached to the heat dissipater 4 in such a way that the circuit board 3, especially the LED elements 31 of the circuit board 3, can be housed in the cover 2. The light guide bar 9 has one end connected to the reflection structure 1 so as to have the light guide bar 9 located inside the cover 2. An opposite end of the light guide bar 9 is set to be opposing and close to at least one LED element 31 of the plurality of LED elements 31 mounted on the circuit board 3. Light emitting from said at least one LED element 31 is incident to the light guide bar 9. The power connector 5 is mounted to a bottom end of the heat dissipater 4.

With proper assembling of the above components, an LED light bulb that can serve as a night light according to the present invention is completed. When a switch that is not shown in the drawings is operated to have the light emitting from said at least one LED element 31 projected to the light guide bar 9, the light is guided by the light guide bar 9 to reach the top of the cover 2 and is emitted outward by the portion of the reflection structure 1 that is exposed outside the cover 2 to thereby serve as a night light. Also, the switch may be alternatively operated to have the remaining ones of the LED elements 31 give off light, and the light is reflected by to a circumferential portion of the cover 2 in order to expand the light emission angle of the LED light bulb (namely large angle emission of light).

The circuit board 3 is arranged at the top end of the heat dissipater 4 and, as shown in the drawings, is received inside the top end of the heat dissipater 4. The reflection structure 1 comprises a first portion 11 that is exposed outside the cover 2 and a second portion 12 that is received inside the cover 2. In the first embodiment shown in FIG. 1, the second portion 12 of the reflection structure 1 has a shape of circular cone. The light guide bar 9 is connected at said one end thereof to the second portion 12 of the reflection structure 1. The cover 2 forms a hole 21 in a top thereof so that the reflection structure 1 is received and fixed in the hole 21 of the cover 2. Specifically, the hole 21 of the cover 2 has an inner circumference along which a first joint rim 211 is formed. The reflection structure 1 has an outer circumference along which a second joint rim 13 is formed to correspond to the first joint rim 211. The second joint rim 13 of the reflection structure 1 is engageable with the first joint rim 211 of the cover 2 to be fixed thereto.

Further, the LED elements 31 mounted on the circuit board 3 are classified as at least two groups, one of which contains LED elements 31 that emit lights of a first color (such as a dark color to be used when the bulb is switched to night light) and the other group contains LED elements 31 that give off lights of a second color (such as a bright color to be used when the bulb is switched to regular illumination).

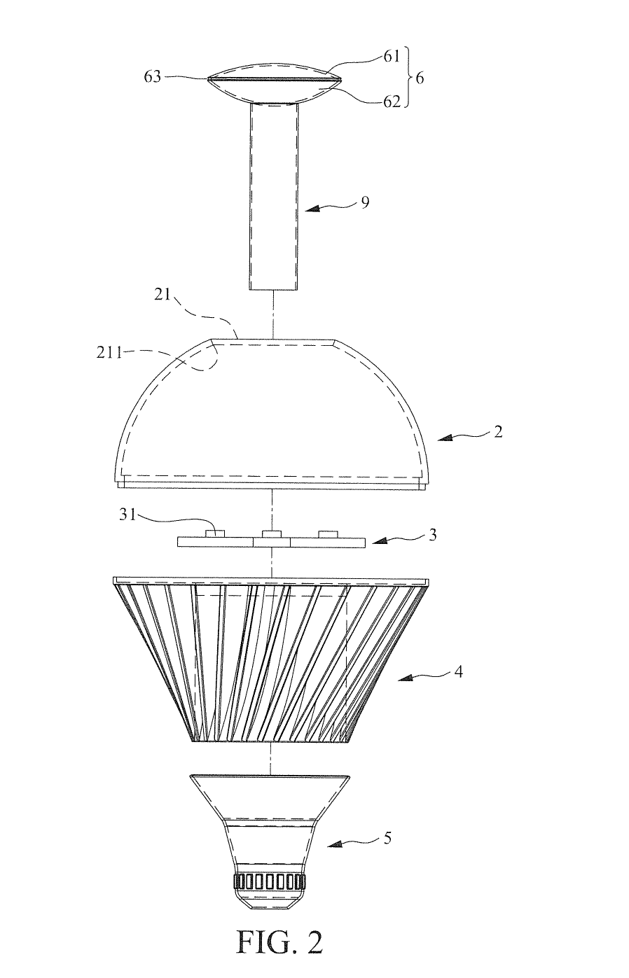

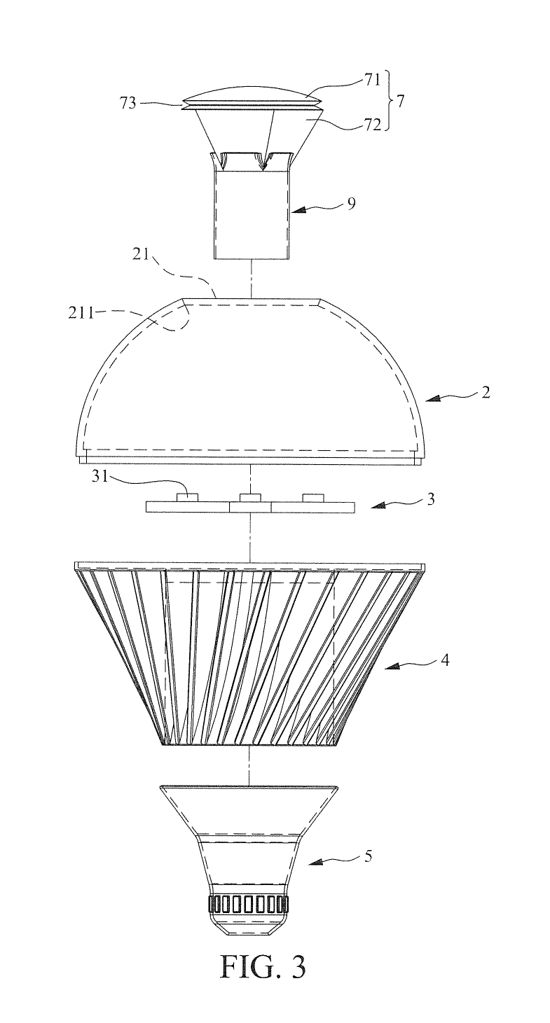

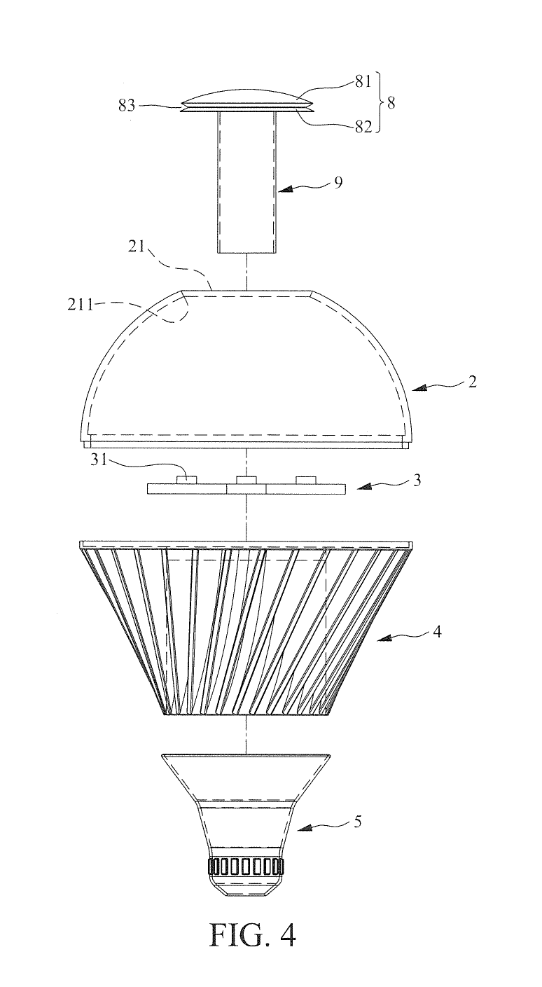

Reference is now made to the second, third, and fourth embodiments shown in FIGS. 2, 3, and 4. The structures of these embodiments are generally identical to the first embodiment, except the reflection structure, which is generally designated at 6, 7, 8 for these embodiments. Regarding to the differences of the second to fourth embodiments from the first embodiment, as shown in FIG. 2, the second embodiment comprises a reflection structure 6 that has a second portion 62 having a circular curved shape; as shown in FIG. 3, the third embodiment of the present invention comprises a reflection structure 7 that has a second portion 72 having a pyramidal shape; and as shown in FIG. 4, the fourth embodiment of the present invention comprises a reflection structure 8 that has a second portion 82 having a planar configuration. Each of the reflection structures 6, 7, 8 has a second joint rim 63, 73, 83 (formed between the first portion 61, 71, 81 and the second portion 62, 72, 82) for engagement with the first joint rim 211 of the cover 2 to be fixed thereto. The light guide bar 9 is connected, at said one end thereof, to the second portion 62, 72, 82 of the reflection structure 6, 7, 8.

In summary, the present invention provides an LED light bulb that can also serve as a night light that is characterized in that the reflection structure 1, 6, 7, 8 is mounted to the top of the cover 2 and the light guide bar is connected to the reflection structure so that, in a condition of being used with a cover 2, a switch can be operated to have some of the LED elements 31 of a different color to give off light of said different color (such as a dark light) that is guided by the light guide bar 9 to reach the top of the cover 2 and is emitted outward through the first portion 11, 61, 71, 81 of the reflection structure 1, 6, 7, 8 that is exposed outside the cover 2 (for use as a night light) so that the LED light bulb can serve as a night light. Further, the switch can be operated to have the remaining ones of the LED elements 31 give off light (such as light of a bright color) that is reflected by the reflection structure 1 to a circumferential portion of the cover 2 so as to expand the light emission angle of the LED light bulb (for use as regular illumination).

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An LED light bulb concurrently serving as night light, comprising:
a cover;
a reflection structure, which is mounted to a top of the cover;
a heat dissipater, which has a top end coupled to a bottom end of the cover;
a circuit board, which comprises a plurality of LED elements mounted thereon, the circuit board being attached to the heat dissipater in such a way that the circuit board is housed in the cover;
a light guide bar, which is received in the cover, the light guide bar having one end connected to the reflection structure and an opposite end opposing to and close at least one LED element of the circuit board, the at least one LED element emitting light that enters the light guide bard; and
a power connector, which is mounted to a bottom end of the heat dissipater.

2. The LED light bulb concurrently serving as night light as claimed in claim 1, wherein the circuit board is attached to the top end of the heat dissipater.

3. The LED light bulb concurrently serving as night light as claimed in claim 1, wherein the reflection structure comprises a first portion that is exposed outside the cover and a second portion that is located inside the cover, said one end of the light guide bar being connected to the second portion of the reflection structure.

4. The LED light bulb concurrently serving as night light as claimed in claim 3, wherein the second portion of the reflection structure has a circular conic shape.

5. The LED light bulb concurrently serving as night light as claimed in claim 3, wherein the second portion of the reflection structure has a circular curved shape.

6. The LED light bulb concurrently serving as night light as claimed in claim 3, wherein the second portion of the reflection structure has a pyramidal shape.

7. The LED light bulb concurrently serving as night light as claimed in claim 3, wherein the second portion of the reflection structure has a planar configuration.

8. The LED light bulb concurrently serving as night light as claimed in claim 1, wherein the cover forms a hole in a top, the reflection structure being mounted in the hole of the cover.

9. The LED light bulb concurrently serving as night light as claimed in claim 8, wherein the hole of the cover has an inner circumference along which a first joint rim is formed, the reflection structure having an outer circumference along which a second joint rim is formed to correspond to the first joint rim, the second joint rim of the reflection structure being engageable with the first joint rim of the cover to be fixed thereto.

10. The LED light bulb concurrently serving as night light as claimed in claim 1, wherein the LED elements mounted on the circuit board are classified as at least two groups, the LED elements of one of the groups emitting lights of a first color, the LED elements of another one of the groups emitting lights of a second color.
